(19) United States
(12) Patent Application Publication
(10) Pub. No.: US 2013/0346318 A1
(43) Pub. Date: Dec. 26, 2013

(54) SECURE TRANSACTION SYSTEMS AND METHODOLOGIES

(71) Applicant: Gur SHATZ, Rehovot (IL)

(72) Inventor: Gur SHATZ, Rehovot (IL)

(73) Assignee: INCAPSULA INC., Dover (DE)

(21) Appl. No.: 13/533,343

(22) Filed: Jun. 26, 2012

(51) Int. Cl. G06Q 20/38

(52) U.S. Cl. 705/71; 705/79

(57) ABSTRACT

A secure transaction system including a content delivery network defining edge gates for secure communication with entities outside the network, each edge gate including at least one of encryption and decryption functionality, the encryption functionality being operative to encrypt customer payment card information into no payment card zone (NPCZ) capsules and the decryption functionality being operative to decrypt the NPCZ capsules into customer payment card information securely supplied to at least one of a plurality of payment processing entities, the content delivery network defining a NPCZ, and a plurality of seller entities within the NPCZ which conduct transactions with a plurality of customers and with at least one of the payment processing entities, and receive, process and transmit customer payment information using the NPCZ capsules, the plurality of seller entities not having access to unencrypted payment card information and not having the ability to decrypt encrypted payment card information.

### FIELD OF THE INVENTION

The present invention relates generally to secure transaction systems and methodologies.

### BACKGROUND OF THE INVENTION

The following publications are believed to represent the current state of the art:

U.S. Pat. Nos. 7,210,622; 7,310,729; 7,660,296; 7,672,873; 7,711,647; 7,743,132; and

U.S. Published Patent Application Nos. 2011/0153380 and 2004/0093419.

### SUMMARY OF THE INVENTION

The present invention seeks to provide improved secure transaction systems and methodologies. There is thus provided in accordance with a preferred embodiment of the present invention a secure transaction system including a content delivery network defining a multiplicity of edge gates for secure communication with entities outside the network, each of the edge gates including at least one of encryption functionality and decryption functionality, the encryption functionality being operative to encrypt customer payment card information into no payment card zone (NPCZ) capsules and the decryption functionality being operative to decrypt the NPCZ capsules into customer payment card information securely supplied to at least one of a plurality of payment processing entities, the content delivery network defining a NPCZ, and a plurality of seller entities entirely within the no payment card zone which conduct transactions with any of a plurality of customers and with at least one of the plurality of payment processing entities, and receive, process and transmit customer payment information using the NPCZ capsules, the plurality of seller entities not having access to unencrypted payment card information and not having the ability to decrypt encrypted payment card information.

Preferably, the content delivery network controls encryption and decryption keys used for the encryption functionality and the decryption functionality but does not store NPCZ capsules. Preferably, the plurality of seller entities do not have access to the encryption and decryption keys used for the encryption functionality and the decryption functionality but do store NPCZ capsules.

Preferably, the plurality of payment processing entities do not have access to the encryption and decryption keys used for the encryption functionality and the decryption functionality, but do store customer payment card information.

In accordance with a preferred embodiment of the present invention, the existence and operation of the content delivery network is transparent to the plurality of customers. Additionally, the existence and operation of the content delivery network is transparent to the plurality of payment processing entities.

There is also provided in accordance with another preferred embodiment of the present invention a secure transaction method in a content delivery network including encrypting, by the content delivery network, customer payment card information received from any of a plurality of customers into no payment card zone (NPCZ) capsules receiving, processing and transmitting encrypted customer payment card information, by a plurality of seller entities, using the NPCZ capsules, decrypting, by the content delivery network, the NPCZ capsules into decrypted customer payment card information, securely supplying, by the content delivery network, the decrypted customer payment card information to at least one of a plurality of payment processing entities, and the plurality of seller entities not accessing unencrypted payment card information and not decrypting encrypted payment card information.

Preferably, the method also includes controlling, by the content delivery network, encryption and decryption keys used for the encrypting and the decrypting. Preferably, the NPCZ capsules are not stored by the content delivery network. Preferably, the method also includes storing the NPCZ capsules by the seller entities. Preferably, the encryption and decryption keys are not accessed by the seller entities.

Preferably, the method also includes storing customer payment card information by the plurality of payment processing entities. Preferably, the encryption and decryption keys are not accessed by the plurality of payment processing entities.

In accordance with a preferred embodiment of the present invention, the existence and operation of the content delivery network is transparent to the plurality of customers. Additionally, the existence and operation of the content delivery network is transparent to the plurality of payment processing entities.

### BRIEF DESCRIPTION OF THE DRAWINGS

The present invention will be understood and appreciated more fully from the following detailed description, taken in conjunction with the drawings in which:

FIG. 1 is a simplified illustration of a secure transaction system constructed and operative in accordance with a preferred embodiment of the present invention;

FIG. 2 is a simplified functional block diagram illustration of one embodiment of the system of FIG. 1; and

FIG. 3 is a simplified flow chart illustrating one embodiment of a secure transaction methodology.

### DETAILED DESCRIPTION OF A PREFERRED EMBODIMENT

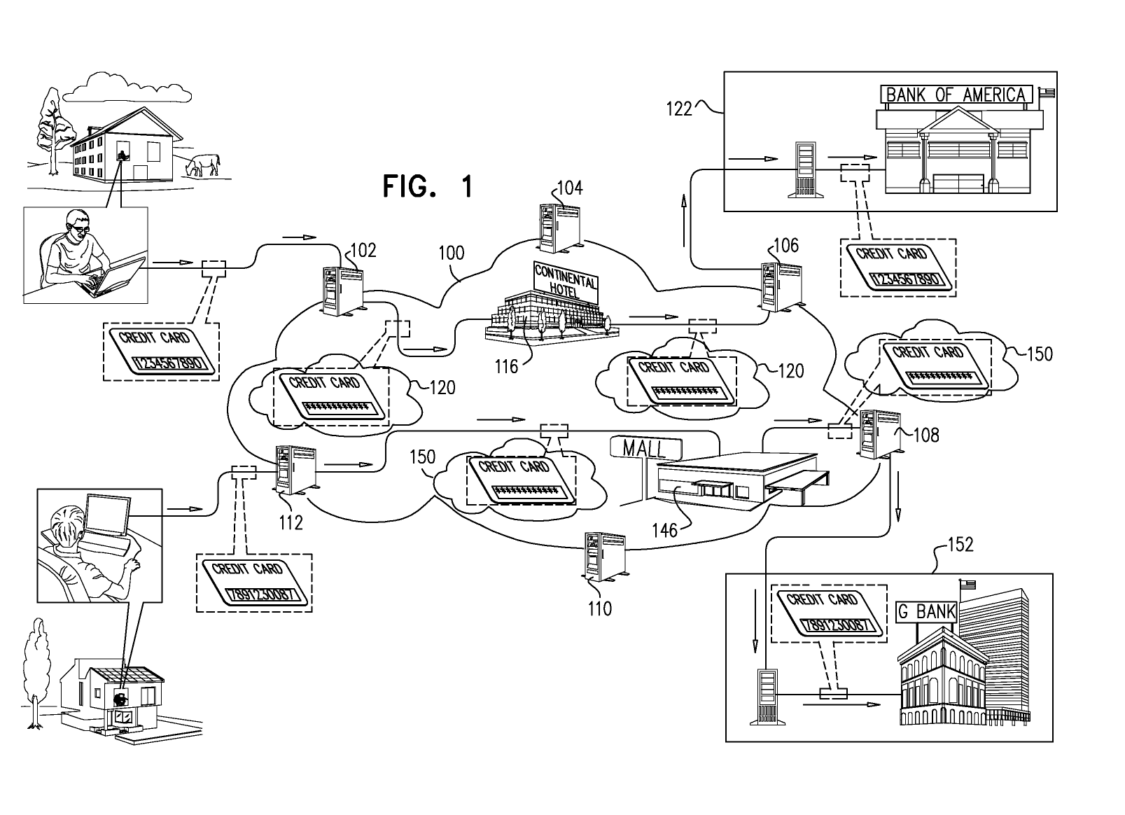

Reference is now made to FIG. 1, which is a simplified illustration of a secure transaction system constructed and operative in accordance with a preferred embodiment of the present invention. As seen in FIG. 1, the secure transaction system includes a content delivery network 100, here depicted as a cloud, which defines a protected zone which encapsulates at least one website.

The content delivery network 100 preferably defines a multiplicity of edge gates, each embodied in at least one computer server for secure communication with entities outside the network. In the illustration of FIG. 1, the computer servers are designated by reference numerals 102, 104, 106, 108, 110 and 112. Each such computer server provides at least one and preferably both of encryption and decryption functionality.

It is appreciated that the decryption functionality can be performed either by one of the computer servers or alternatively by an additional server (not shown), which is not part of the content delivery network.

It is further appreciated that the decryption functionality may be implemented by using either a forward proxy or a reverse proxy.

It is a particular feature of the present invention that, by prohibiting unencrypted customer payment card information from being present in the protected zone, the content delivery network defines a No Payment Card Zone.

The aforesaid encryption functionality is operative to encrypt customer payment card information into NPCZ (No Payment Card Zone) capsules which do not contain customer payment card information in a non-encrypted form.

The aforesaid decryption functionality is operative to decrypt the NPCZ capsules into customer payment card information which is securely supplied to at least one of a plurality of PPEs (Payment Processing Entities). For the purposes of the present application, the term “Payment Processing Entities” includes one or more of Credit Card Payment Processors, such as FirstData and TSYS, and Payment Gateways, such as Authorize.net®, WorldPay™ and Beanstream®. The Payment Processing Entities preferably do not have access to encryption and decryption keys or to NPCZ capsule encryption and decryption functionality.

It is appreciated that content delivery network 100 is operative to manage encryption and decryption keys used by the encryption functionality and the decryption functionality provided by the computer servers. The computer servers preferably do not store encrypted NPCZ capsules.

It is a particular feature of the present invention that the at least one website may include a plurality of seller entities. The seller entities preferably conduct transactions with any of a plurality of customers and with multiple PPEs, and preferably receive, process and transmit customer payment information using the NPCZ capsules without the plurality of seller entities having access to any of unencrypted payment card information, encryption and decryption keys, and NPCZ capsule decryption functionality.

As shown in FIG. 1, a customer of a seller entity 116, such as the Continental Hotel, initiates a transaction with seller entity 116. As clearly shown in FIG. 1, upon reaching a first edge gate embodied in server 102, the customer's payment card information is encrypted into an NPCZ capsule 120 by encryption functionality provided by server 102. NPCZ Capsule 120 is preferably routed by server 102 to seller entity 116, which then forwards NPCZ capsule 120 to a PPE 122, such as, for example, a Bank of America payment processing center, via a second edge gate embodied in server 106. It is appreciated that alternatively, depending on the location of PPE 122, seller entity 116 may forward NPCZ capsule 120 to PPE 122 via the first edge gate embodied in server 102.

Upon reaching server 106, NPCZ capsule 120 is decrypted by decryption functionality provided by server 106 into the original customer payment card information, which is then securely supplied to PPE 122, thereby completing the transaction. As mentioned hereinabove, it is appreciated that the decryption functionality may be implemented by using either a forward proxy or a reverse proxy. It is also appreciated that the existence and operation of content delivery network 100, which facilitates of the aforementioned path of customer payment card information from the customer to PPE 122, is transparent to both the customer and to PPE 122.

As further shown in FIG. 1, a customer of a seller entity 146, such as a local mall, initiates a transaction with seller entity 146. As clearly shown in FIG. 1, upon reaching a third edge gate embodied in server 112, the customer's payment card information is encrypted into an NPCZ capsule 150 by encryption functionality provided by server 112. NPCZ Capsule 150 is preferably routed by server 112 to seller entity 146, which then forwards NPCZ capsule 150 to a PPE 152, such as, for example, a G Bank processing center, via a fourth edge gate embodied in server 108. It is appreciated that alternatively, depending on the location of PPE 152, seller entity 146 may forward NPCZ capsule 150 to PPE 152 via the third edge gate embodied in server 112.

Upon reaching server 108, NPCZ capsule 150 is decrypted by decryption functionality provided by server 108 into the original customer payment card information, which is then securely supplied to PPE 152, thereby completing the transaction. As mentioned hereinabove, it is appreciated that the decryption functionality may be implemented by using either a forward proxy or a reverse proxy. It is also appreciated that the existence and operation of content delivery network 100, which facilitates of the aforementioned path of customer payment card information from the customer to PPE 152, is transparent to both the customer and to PPE 152.

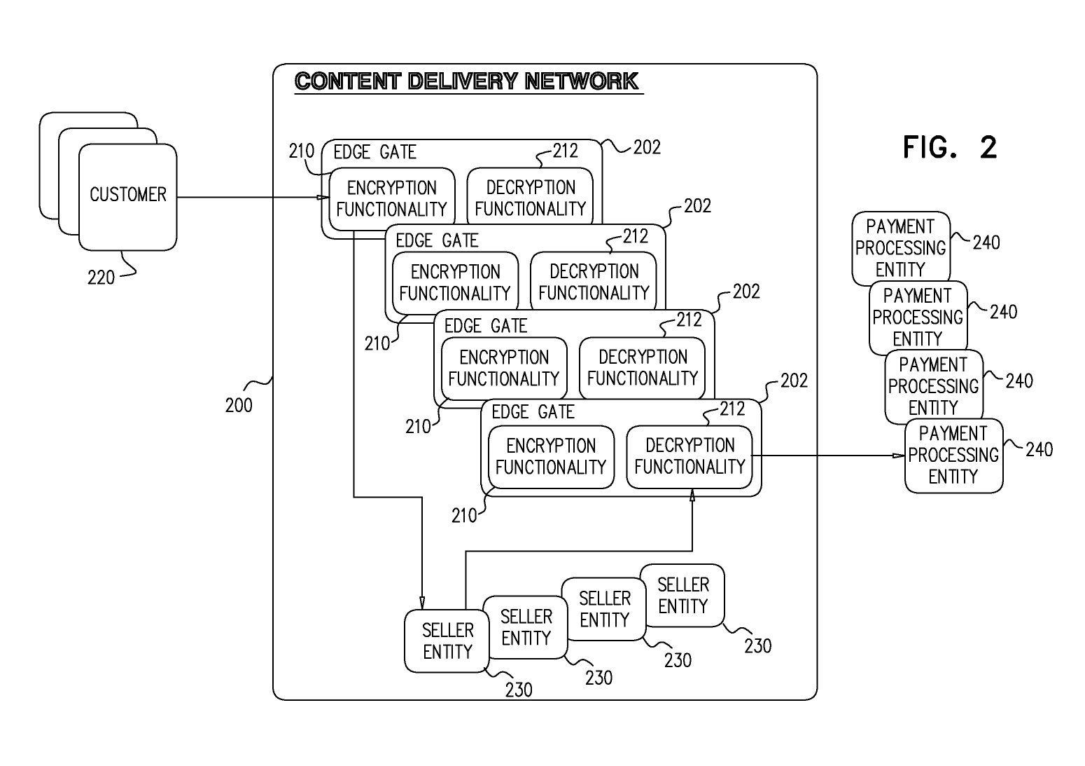

Reference is now made to FIG. 2, which is a simplified functional block diagram illustration of one embodiment of the system of FIG. 1. As shown in FIG. 2, a content delivery network 200 preferably comprises a multiplicity of edge gates 202. Each of edge gates 202 preferably comprises encryption functionality 210 and decryption functionality 212. A plurality of customers 220 preferably communicate with content delivery network 200 via edge gates 202, where customer payment card information is encrypted by encryption functionality 210.

A plurality of sellers 230 are operative to receive encrypted customer payment card information from edge gates 202 and to process and transmit encrypted customer payment information using the NPCZ capsules to edge gates 202 where encrypted customer payment card information is decrypted by decryption functionality 212. Decrypted customer payment card information is then transmitted to any of a plurality of payment processing entities 240.

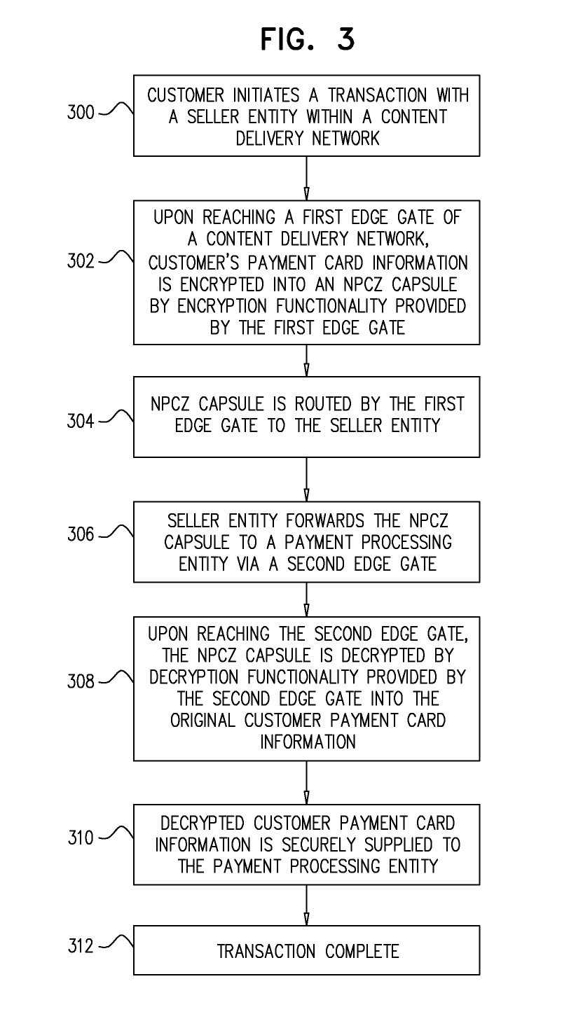

Reference is now made to FIG. 3, which is a simplified flow chart illustrating one embodiment of a secure transaction methodology. As shown in FIG. 3, a customer initiates a transaction with a seller entity within a content delivery network (300). Upon reaching a first edge gate of a content delivery network, the customer's payment card information is encrypted into an NPCZ capsule by encryption functionality provided by the first edge gate (302).

Thereafter, the NPCZ capsule is preferably routed by the first edge gate to the seller entity (304), which then forwards the NPCZ capsule to a payment processing entity via a second edge gate (306).

Upon reaching the second edge gate, the NPCZ capsule is decrypted by decryption functionality provided by the second edge gate into the original customer payment card information (308). The decrypted customer payment card information is then securely supplied to the payment processing entity (310), thereby completing the transaction (312).

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to persons skilled in the art upon reading the foregoing description and which are not in the prior art.

1. A secure transaction system comprising:
a content delivery network defining a multiplicity of edge gates for secure communication with entities outside the network, each of said edge gates comprising at least one of encryption functionality and decryption functionality, said encryption functionality being operative to encrypt customer payment card information into no payment card zone (NPCZ) capsules and said decryption functionality being operative to decrypt said NPCZ capsules into customer payment card information securely supplied to at least one of a plurality of payment processing entities, said content delivery network defining a NPCZ; and
a plurality of seller entities entirely within said no payment card zone which conduct transactions with any of a plurality of customers and with at least one of said plurality of payment processing entities, and receive, process and transmit customer payment information using said NPCZ capsules, said plurality of seller entities not having access to unencrypted payment card information and not having the ability to decrypt encrypted payment card information.

2. A secure transaction system according to claim 1 and wherein said content delivery network controls encryption and decryption keys used for said encryption functionality and said decryption functionality but does not store NPCZ capsules.

3. A secure transaction system according to claim 2 and wherein said plurality of seller entities do not have access to said encryption and decryption keys used for said encryption functionality and said decryption functionality but do store NPCZ capsules.

4. A secure transaction system according to claim 2 and wherein said plurality of payment processing entities do not have access to said encryption and decryption keys used for said encryption functionality and said decryption functionality, but do store customer payment card information.

5. A secure transaction system according to claim 1 and wherein the existence and operation of said content delivery network is transparent to said plurality of customers.

6. A secure transaction system according to claim 1 and wherein the existence and operation of said content delivery network is transparent to said plurality of payment processing entities.

7. A secure transaction method in a content delivery network comprising:
encrypting, by said content delivery network, customer payment card information received from any of a plurality of customers into no payment card zone (NPCZ) capsules;
receiving, processing and transmitting encrypted customer payment card information, by a plurality of seller entities, using said NPCZ capsules;
decrypting, by said content delivery network, said NPCZ capsules into decrypted customer payment card information;
securely supplying, by said content delivery network, said decrypted customer payment card information to at least one of a plurality of payment processing entities; and
said plurality of seller entities not accessing unencrypted payment card information and not decrypting encrypted payment card information.

8. A secure transaction method according to claim 7 and also comprising controlling, by said content delivery network, encryption and decryption keys used for said encrypting and said decrypting.

9. A secure transaction method according to claim 7 and wherein said NPCZ capsules are not stored by said content delivery network.

10. A secure transaction method according to claim 7 and also comprising storing said NPCZ capsules by said seller entities.

11. A secure transaction method according to claim 8 and wherein said encryption and decryption keys are not accessed by said seller entities.

12. A secure transaction method according to claim 7 and also comprising storing customer payment card information by said plurality of payment processing entities.

13. A secure transaction method according to claim 7 and wherein said encryption and decryption keys are not accessed by said plurality of payment processing entities.

14. A secure transaction method according to claim 7 and wherein the existence and operation of said content delivery network is transparent to said plurality of customers.

15. A secure transaction method according to claim 7 and wherein the existence and operation of said content delivery network is transparent to said plurality of payment processing entities.
